(19) United States
(12) Patent Application Publication
(10) Pub. No.: US 2025/0287864 A1
(43) Pub. Date: Sep. 18, 2025

(54) METERING UNIT FOR A SEED DRILL AND ASSOCIATED ISOLATION METHOD

(71) Applicant: KUHN SAS, Saverne (FR)

(72) Inventor: Olivier CONSTANT, Weiterswiller (FR)

(73) Assignee: KUHN SAS, Saverne (FR)

(21) Appl. No.: 19/068,047

(22) Filed: Mar. 3, 2025

(30) Foreign Application Priority Data
Mar. 15, 2024 (FR) FR2402630

(51) Int. Cl. A01C 7/10; A01C 7/20

(52) U.S. Cl. CPC A01C 7/102; A01C 7/208

(57) ABSTRACT

A metering unit for a seed drill comprising: an airtight casing comprising a fixed part and a movable door, the fixed part of the casing comprises an inlet for granular elements associated with a shutter operable by a selection element for placing the shutter in a sealed position or in an access position, in the closed position the door is locked in a locked state or unlocked in an unlocked state by a locking device, wherein in the closed position of the door, the locking device and the selection element are configured so that:
as long as the shutter is in the access position the door is held in the locked state by the locking device, and
operation of the selection element to pass the shutter from the access position to the sealed position causes operation of the locking device so as to allow the door to pass to the unlocked state.

### BACKGROUND OF THE INVENTION

### Field of the Invention

The present invention relates to the field of metering units for a seed drill.

The invention therefore relates more generally to the field of single seeding, also known as precision seeding, in other words seeding in rows of seeds, one by one. Single seeding is used for maize, beet, soy or similar crops.

### Description of the Related Art

A single-grain seed drill generally takes the form of a beam-chassis on which seeder elements are fixed, most often between 4 and 12, or even more, by means of a parallelogram. The spacing between these seeder elements varies according to the crop, preferably between 37.5 centimeters and 80 centimeters, but allows the formation of very distinct rows. For this reason, it is common in this case to refer to row crops, as opposed to crops such as wheat where the spacing is much more compact.

In a known manner, a metering unit for a single-grain seed drill operates on the whole in the manner set out below.

A two-part airtight casing has a drilled metering disc driven in rotation, preferably by a motor that forms a metering element for a plurality of granular elements. The metering disc separates the casing into two chambers with different air pressures, thereby creating a pressure difference which may be positive or negative on either side of the drilled metering disc. The casing is connected to a blower that manages the pressure difference according to the type of seed, speed of advance, and other parameters.

Under the drilled metering disc, in other words at the bottom of the casing, there is a reserve zone for granular elements, for example seeds, usually supplied by a hopper. These seeds are in contact with the drilled metering disc in rotation which, as it rotates, will drag the seeds one by one into its drilling holes.

The diameter and shape of the drilling holes of the metering disc are made so as to be able to accommodate a single granular element, for example a seed, with the granular element held in the drilling hole by the pressure difference between the two sides of the metering disc. The drilling holes are often bordered by special shapes, for example in relief and/or hollow, and arranged in the metering disc so as to guide and/or direct the seeds towards the drilling hole. These zones around the drilling holes are commonly known as stirrer elements.

Once the seeds have been distributed in the drilling holes of the metering disc, a system known as a selection system makes it possible to eliminate the excess seeds to avoid duplication, since several seeds may come to be contained in a single drilling hole, which is not desirable. The selection can be made using teeth, brushes or similar, that are fixedly mounted and are located outside and/or inside the path of the seeds. As a result, the excess seeds fall back into the reserve zone.

Once the seeds have been selected, they are transported to the last distribution zone, which is generally located in the last quarter turn of the metering disc, where there is no longer a pressure difference. This lack of a pressure difference causes the seed to exit the drilling hole and exit the metering unit towards the ground. The ejection of the seed can be assisted by a roller used to cut the pressure difference and possibly push the seed out of the drilling hole by means of pegs.

In certain situations, the movable door of the airtight casing must be opened, for example, to change the metering disc and/or to perform a cleaning and/or maintenance operation and/or a draining of the seeds and/or adjustments.

In these cases, it is desirable to be able to isolate the casing from the hopper containing the seeds in order to prevent them from entering the casing.

To do this, the inlet for seeds into the casing takes the form of a pipe, which is selectively opened or not opened by a shutter. The shutter may also partially open to affect the seed inlet flow into the casing.

When it is desirable to isolate the casing from the hopper, this inlet must be completely sealed by closing the shutter. The shutter is moved between its different positions by a lever operated manually by the operator. The lever is mounted on the outside of the metering casing. A display on the casing indicates the position of the lever.

Until now, the operator had to make sure that they had properly closed the seed inlet before opening the door of the casing. Otherwise, the seeds would continue to flow into the casing and fall to the ground when the operator will dismount the metering disc. However, it is not uncommon for the operator to forget to close the seed inlet, meaning the seeds then sometimes accidentally fall to the ground.

### SUMMARY OF THE INVENTION

The present invention is intended to overcome at least one of these drawbacks and aims to provide a solution making it possible to automatically isolate the casing from the hopper under certain conditions.

To this end, the invention concerns a metering unit for a seed drill comprising at least:
an airtight casing comprising at least a fixed part and a door that can be moved between an open position and a closed position,
a metering element for a plurality of granular elements, arranged for discrete and singular distribution of a plurality of granular elements,
the metering element being placed inside the casing to separate the interior of the casing into a first chamber and second chamber, which are different, the first chamber being configured to receive all or part of the plurality of granular elements at least in a reserve zone, and the second chamber being closed with the door at least in its closed position,
the fixed part of the casing further comprises an inlet for granular elements leading into the first chamber associated with a shutter, said inlet for granular elements being configured to be connected to conveying means connected to a hopper,
the shutter being operable by a selection element to at least selectively place the shutter in a sealed position of the inlet for granular elements in which the shutter seals the inlet for granular elements, or in an access position of the inlet for granular elements in which the shutter does not fully or partially seal the inlet for granular elements,
in the closed position, the door is at least locked in a locked state or unlocked in an unlocked state at least by a locking device, the metering unit is one wherein:
in the closed position of the door, the locking device and the selection element are configured so that:
as long as the shutter is in the access position or is not in the sealed position, the door is held in the locked state by the locking device, and
operation of the selection element to pass the shutter from the access position to the sealed position causes operation of the locking device so as to allow the door to pass to the unlocked state or cause the door to move to the unlocked state.

The invention also relates to a seeder element comprising at least one hopper arranged to contain a plurality of granular elements and being connected by the conveying means to the metering unit, wherein the metering unit is in accordance with the invention.

The invention also relates to a seed drill comprising at least one chassis on which at least one seeder element is mounted, wherein the at least one seeder element is in accordance with the invention.

The invention also relates to a locking/unlocking method for a metering unit for a seed drill comprising a plurality of granular elements at least in the reserve zone, wherein the metering unit is in accordance with the invention and in that the method comprises:
a locking stage, during which in the closed position of the door, the shutter is placed in the access position and the door is held in the locked state by the locking device, and
an isolation stage, during which in the closed position of the door, the selection element is operated to pass the shutter from the access position to the sealed position, causing operation of the locking device so as to allow the door to pass to the unlocked state or cause the door to pass to the unlocked state.

### BRIEF DESCRIPTION OF THE DRAWINGS

The invention will be better understood through the following description, which refers to several preferred embodiments given as non-limiting examples and explained with reference to the attached schematic drawings, in which:

FIG. 1 shows a perspective view of a metering unit according to the invention comprising a door held in a locked state by a locking device and a selection element configured so that a shutter is in an access position,

FIG. 2 shows a front view of the metering unit in FIG. 1,

FIG. 3 shows a partial perspective view of the door and the locking device of the metering unit in FIG. 1,

FIG. 4 shows a rear view of the metering unit in FIG. 1,

FIG. 5 shows a partial perspective view of the selection element of the metering unit in FIG. 1,

FIG. 6 shows a front view of the metering unit in FIG. 1 without the door,

FIG. 7 shows a front view of the metering unit according to the invention comprising the door held in a locked state by the locking device and the selection element configured so that the shutter is in a sealed position,

FIG. 8 shows a partial perspective view of the selection element of the metering unit in FIG. 7,

FIG. 9 shows a front view of the metering unit according to the invention comprising the door in an unlocked state and the selection element configured so that the shutter is in the sealed position,

FIG. 10 shows a front view of the metering unit according to the invention comprising the selection element configured so that the shutter is in the sealed position and with the door removed,

FIG. 11 shows a perspective view of a part of the selection element and the shutter of the metering unit in FIG. 1, and

FIG. 12 shows a perspective view of the door and a metering element of the metering unit in FIG. 1.

### DETAILED DESCRIPTION OF THE PREFERRED EMBODIMENTS

As illustrated in the figures, a metering unit for a seed drill comprises at least:
an airtight casing 1 comprising at least a fixed part 2 and a door 3 that can be moved between an open position PON and a closed position POFF,
a metering element 4 for a plurality of granular elements, arranged for discrete and singular distribution of a plurality of granular elements,
the metering element 4 being placed inside the casing 1 to separate the interior of the casing 1 into a first chamber 5 and a second chamber 6, which are different, the first chamber 5 being configured to receive all or part of the plurality of granular elements at least in a reserve zone 7, and the second chamber 6 being closed with the door 3 at least in its closed position POFF,
the fixed part 2 of the casing 1 further comprises an inlet 8 for granular elements leading into the first chamber 5 associated with a shutter 9, said inlet 8 for granular elements being configured to be connected to conveying means 10, 11 connected to a hopper (not shown),
the shutter 9 being operable by a selection element 12 to at least selectively place the shutter 9 in a sealed position PO of the inlet 8 for granular elements in which the shutter 9 seals the inlet 8 for granular elements, or in at least one access position PA of the inlet 8 for granular elements in which the shutter 9 does not fully or partially seal the inlet 8 for granular elements,
in the closed position POFF, the door 3 is at least locked in a locked state E1 or unlocked in an unlocked state E2 at least by a locking device 13.

According to the invention, the metering unit is one wherein:
in the closed position POFF of the door 3, the locking device 13 and the selection element 12 are configured so that:
as long as the shutter 9 is in the access position PA or is not in the sealed position PO, the door 3 is held in the locked state E1 by the locking device 13, and
operation of the selection element 12 to pass the shutter 9 from the access position PA to the sealed position PO causes operation of the locking device 13 so as to allow the door 3 to pass to the unlocked state E2 or cause the door 3 to pass to the unlocked state E2.

Advantageously, thanks to this configuration, the operator is only authorized to open the door 3 by passing it from the closed position POFF to the open position PON after the selection element 12 has operated the shutter 9 so that it is in the sealed position PO, with the shutter 9 in this latter position sealing the inlet 8 for granular elements. Consequently, under these conditions, the contents of the hopper are isolated from the first chamber 5 of the casing 1, which implies that, in the event of the opening of the door 3 of the casing 1, no granular element will continue to arrive in the first chamber 5 of the casing 1 from the hopper via the conveying means 10, 11. In other words, the total closure of the inlet 8 using the shutter 9 is made mandatory if the door 3 is to be opened.

Indeed, the door 3 is kept closed in the closed position POFF if the shutter 9 is in the access position PA allowing the granular elements to enter via the inlet 8 into the first chamber 5 of the casing 1, due to the latter being locked by the locking device 13 which prevents the opening of the door 3, with this therefore being in the locked state E1. Furthermore, the door 3 can be opened in the open position PON if the shutter 9 is in the sealed position PO preventing the granular elements from entering the first chamber 5 of the casing 1 via the inlet 8, due to the operation of the locking device 13 by the selection element 12 which authorizes the unlocking of the locking device 13 or causes the unlocking of the locking device 13. Under these latter conditions, the passing of the door 3 from the locked state E1 to the unlocked state E2 is made possible or automatic.

Preferably, the locking device 13 comprises a first locking element 14 and a second locking element 15, in the closed position POFF, the door 3 is at least locked in the locked state E1 or unlocked in the unlocked state E2 at least by the first locking element 14, the second locking element 15 can be moved between a locking position PV and an unlocking position PDV, and in the closed position POFF of the door 3 the second locking element 15 and the selection element 12 being configured to cooperate with each other so that:
the second locking element 15 remains in the locking position PV as long as the shutter 9 is in the access position PA or is not in the sealed position PO so as to prevent the unlocking of the first locking element 14 in order to hold the door 3 in the locked state E1, and
the operation of the selection element 12 to pass the shutter 9 to the sealed position PO causes the second locking element 15 to pass from the locking position PV to the unlocking position PDV so as to authorize the unlocking of the first locking element 14 and the passing of the door 3 from the locked state E1 to the unlocked state E2.

In this configuration, thanks to the first locking element 14, the door 3 can be locked in the locked state E1 or unlocked in the unlocked state E2 and can pass from one state to the other. Thanks to the second locking element 15 which can interact with the selection element 12, the door 3 can be blocked in the locked state E1 provided that the second locking element 15 is in the locking position PV and the door 3 can be authorized to pass from the locked state E1 to the unlocked state E2 if the second locking element 15 is in the unlocking position PDV. If the selection element 12 places the shutter 9 in the access position PA, then the second locking element 15 is in the locking position PV. On the other hand, if the selection element 12 places the shutter 9 in the sealed position PO, then the second locking element 15 is in the unlocking position PDV.

Preferably, in the at least one access position PA of the shutter 9 corresponding to at least a first position P1 of the selection element 12, the selection element 12 is configured not to operate the second locking element 15 so that it remains in the locking position PV.

Advantageously, in this configuration, in the first position or positions P1, the selection element 12 and the second locking element 15 do not mechanically cooperate with each other. The second locking element 15 is in the locking position PV.

Preferably, in the sealed position PO of the shutter 9 corresponding to a second position of the selection element 12, the selection element 12 is configured to operate the second locking element 15 so that it is in the unlocking position PDV.

Advantageously, in this configuration, in the second position, the selection element 12 and the second locking element 15 cooperate mechanically with each other. The second locking element 15 is in the unlocking position PDV.

Preferably, the selection element 12 comprises a lever 16 mounted so as to be mobile on the fixed part 2 of the casing 1, at least selectively positionable in the at least one first position P1 and the second position and being mechanically connected to the shutter 9, and preferably comprising a gripping device 26 so as to manually operate the lever 16.

Advantageously, this non-limiting example of a selection element 12 is easy to handle for the operator.

Preferably, in the closed position POFF, the door 3 covers an opening 17 of the fixed part 2, the door 3 being mounted so that it can be screwed/unscrewed relative to said opening 17 by the first locking element 14 in the closed position POFF between the locked state E1 in which the door 3 is screwed on and the unlocked state E2 in which the door 3 is unscrewed.

Advantageously, in this non-limiting example, if the door 3 is screwed onto the fixed part 2, it is in the locked state E1, and if the door 3 is unscrewed from the fixed part 2, it is in the unlocked state E2. In this unlocked state E2, the door 3 is no longer attached to the fixed part 2 and can therefore be removed from the fixed part 2 so as to no longer cover the opening 17 and to be placed in the open position PON.

Preferably, the second locking element 15 comprises a latch 18 pivotally mounted on the fixed part 2 of the casing 1 between the locking position PV and the unlocking position PDV and reset by reset means 19 mounted on the fixed part 2 of the casing 1 and a protrusion 20 protruding from the outer periphery of the door 3, the latch 18 being held against the protrusion 20 by the reset means 19 in the locking position PV so as to prevent the rotation of the door 3 to keep the door 3 in the locked state E1, and the latch 18 being at a distance from the protrusion 20 in the unlocking position PDV so as to allow the rotation of the door 3 to allow the door 3 to pass to the unlocked state E2.

Advantageously, in this non-limiting example, if the latch 18 is against the protrusion 20, which corresponds to the locking position PV, then the door 3 cannot be driven in rotation and therefore cannot be unscrewed, and is therefore blocked in the locked state E1. On the other hand, if the latch 18 is at a distance from the protrusion 20, which corresponds to the unlocking position PDV, the door 3 can be driven in rotation and therefore be unscrewed, and can therefore pass to the unlocked position E2.

Preferably, the latch 18 comprises a portion 21 operable by the lever 16 and when passing to the second position, the lever 16 is configured to operate the operable portion 21 and to exert a force against the return force of the reset means 19 and pivot the latch 18 into the unlocking position PDV.

In this non-limiting example, thanks to the mechanical cooperation between the selection element 12 and the second locking element 15 which is in the form of the pivoting latch 18, during the passing from the first position P1 to the second position of the selection element 12, the passing from the locking position PV to the unlocking position PDV of the second locking element 15 can be caused by means of the operable portion 21.

The invention also relates to a seeder element comprising at least one hopper arranged to contain a plurality of granular elements and being connected by the conveying means 10, 11 to the metering unit, wherein the metering unit is in accordance with the invention and as described previously.

The invention also relates to a seed drill comprising at least one chassis on which at least one seeder element is mounted, wherein the at least one seeder element is in accordance with the invention and as described previously.

The invention also relates to a locking/unlocking method for a metering unit for a seed drill comprising a plurality of granular elements at least in the reserve zone 7, wherein the metering unit is in accordance with any one of the claims of the invention and the method comprises:
a locking stage, during which in the closed position POFF of the door 3, the shutter 9 is placed in the access position PA and the door 3 is held in the locked state E1 by the locking device 13, and
an isolation stage, during which in the closed position POFF of the door 3, the selection element 12 is operated to pass the shutter 9 from the access position PA to the sealed position PO, causing operation of the locking device 13 so as to allow the door 3 to pass to the unlocked state E2 or cause the door 3 to pass to the unlocked state E2.

Advantageously, thanks to the method according to the invention, during the locking stage, the inlet 8 is partially or totally opened by the shutter 9 (access position PA) and the door 3 is kept closed by the locking device 13. Even if the inlet 8 allows the granular elements to enter the first chamber 5 of the casing 1, the door 3 cannot be opened. Consequently no granular elements can exit the casing 1.

During the isolation stage, the inlet 8 is closed by the shutter 9 (sealed position PO) and the door 3 can be opened. The inlet 8 no longer allows the entry of new granular elements into the first chamber 5 of the casing 1, the door 3 can be opened, consequently no granular elements coming directly from the hopper via the conveying means 10, 11 can exit the casing 1, even if the metering element 4 is subsequently removed. If necessary, only granular elements remaining in the reserve zone 7 will be able to exit the casing 1 if the metering element 4 is removed after opening the door 3. If applicable, these granular elements remaining in the reserve zone 7 may be drained by a drain chute (not shown) to prevent them from falling to the ground.

The casing 1 comprises the fixed part 2 and the door 3 which can be moved relative to the fixed part 2 and allows the casing 1 to be opened to give access to the inside of the casing 1 or to close it. The door 3 therefore adopts either an open position PON or a closed position POFF. In the open position PON, the door 3 may, if applicable, be completely removed from the fixed part 2 or be connected to it while giving access to the inside of the casing 1. The door 3 is preferably cylindrical with a flat bottom.

The metering element 4 preferably usually comprises a drilled metering disc driven in rotation, preferably by a motor. The metering disc separates the casing into two chambers, the first chamber 5 and the second chamber 6, in which the air pressures are preferably different. The first chamber 5 and the second chamber 6 are preferably substantially cylindrical. The door 3 preferably receives the metering disc, but this example is not limiting.

The reserve zone 7 is located in the first chamber 5. It may contain a certain amount of granular elements from the hopper. The reserve zone 7 is located at the bottom of the fixed part 2 of the casing 1.

The inlet 8 for granular elements is located in the fixed part 2 and opens into the first chamber 5. Preferably, the inlet 8 consists of an opening.

The shutter 9 is designed to adopt the access position(s) PA in which the shutter 9 does not cover the inlet 8 or only partially covers the inlet 8, or the sealed position PO in which the shutter 9 covers the inlet 8. In the access position(s) PA, the shutter 9 allows a different flow of granular elements to arrive via the inlet 8 into the first chamber 5. In the sealed position PO, no granular element can arrive via the inlet 8 into the first chamber 5.

The function of the conveying means 10, 11 is to connect the hopper to the first chamber 5 of the casing 1 and thus lead into the inlet 8. The conveying means preferably comprise at least one duct and preferably a lower duct 10 and an upper duct 11. The lower duct 10 leads into the first chamber 5 via the inlet 8. The upper duct 11 is intended to be connected to the hopper and to the lower duct 10.

The hopper is used to store granular elements, for example seeds or inputs in granular form.

The selection element 12 makes it possible to control the flow of the granular elements through the inlet 8. The selection element 12 in fact makes it possible to operate the shutter 9 in order to pass it to the access position(s) PA or to the sealed position PO. The selection element 12 may itself adopt one or more first positions P1 in which the access position(s) PA are selected or a second position in which the sealed position PO is selected.

The selection element 12 preferably comprises the lever 16 connected to the shutter 9 by fastening means 22. This lever 16 is preferably mounted on the fixed part 2 by a sliding joint formed between a protruding stud 23 of the lever 16 and an elongated through-opening 24 which is arranged on the fixed part 2 and which is curved. The protruding stud 23 is mounted so as to be able to slide in the through-opening 24. The through-opening 24 preferably comprises indentations 25′ on its inner wall 25 representing the different first positions P1 and, for example, marked by displays. The lever 16 preferably comprises at its free end 16a a gripping device 26 in the form of a handle to facilitate gripping. The shutter 9 preferably comprises a flat portion 29 at its free end 30 opposite the free end 16a of the lever 16. The flat portion 29 has dimensions sufficient to cover the inlet 8. The lever 16 can operate the operable portion 21 of the latch 18 when the selection element 12 is in the second position, otherwise it is at a distance from it.

The function of the locking device 13 is to lock the door 3 in a locked state E1, in which the door 3 remains in the closed position POFF as long as the shutter 9 is not in the sealed position PO. The locking device 13 also has the function of unlocking the door 3 in an unlocked state E2, in which the door 3 can be opened in the open position PON, provided that the shutter 9 is in the sealed position PO. Preferably, the locking device 13 comprises a first locking element 14 and a second locking element 15. Therefore, a double locking level is advantageously obtained.

The position of the first locking element 14 depends on the position of the second locking element 15. Therefore, if the second locking element 15 is in the locking position PV, the first locking element 14 locks the door 3 in the locked state E1. On the contrary, if the second locking element 15 is in the unlocking position PDV, the first locking element 14 makes it possible to unlock the door 3 to the unlocked state E2.

The position of the second locking element 15 has the distinctive feature of being dependent on the position of the shutter 9. Therefore, if the shutter 9 is in the access position(s) PA, then the second locking element 15 is in the locking position PV. On the contrary, if the shutter 9 is in the sealed position PO, then the second locking element 15 is in the unlocking position PDV. Preferably, the second locking element 15 can be operated by the selection element 12 which is connected to the shutter 9. Thanks to this dependence, it is mandatory for the shutter 9 to be in the sealed position PO, in other words for the selection element 12 to be in the second position, and therefore for the hopper and the casing 1 to be isolated from each other, so that the door 3 can be opened in the open position PON, since under these conditions the unlocking of the first locking element 14 is possible.

The opening 17 preferably gives access to the inside of the first chamber 5 when the door 3 is removed. The opening 17 is preferably circular.

The latch 18 is preferably mounted so as to be mobile on the fixed part 2 by a rotation axis 27. It rests against the protrusion 20 in the locking position PV. It is at a distance from the protrusion 20 in the unlocking position PDV.

The reset means 19 preferably comprise a compression spring 28. The compression spring 28 presses the latch 18 against the protrusion 20 in the locking position PV.

The protrusion 20 is preferably a rib or a tooth.

The operable portion 21 of the latch 18 is preferably a protruding portion such as a pin or teat.

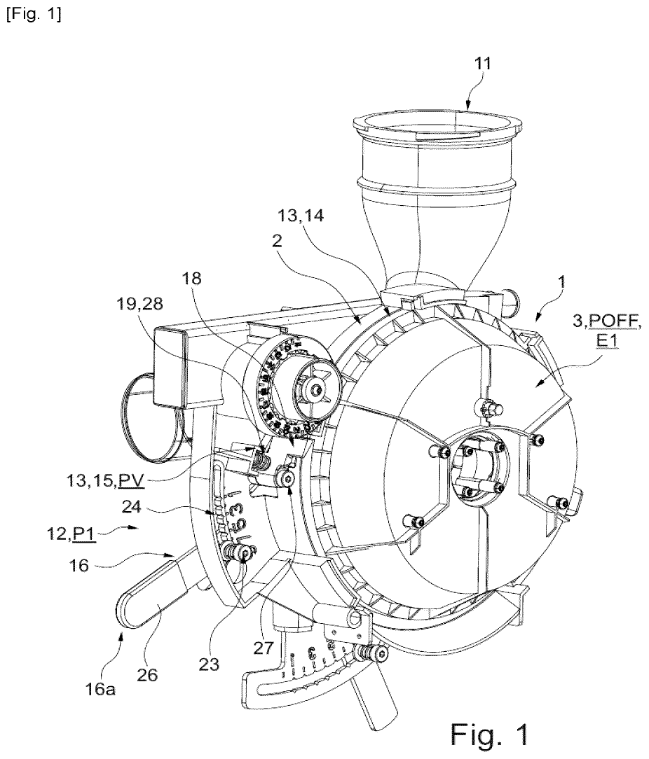

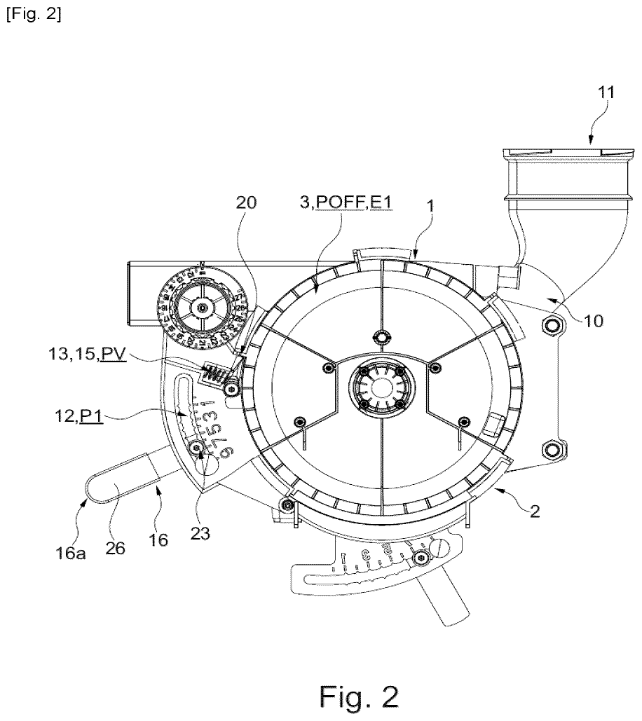

FIGS. 1 and 2 illustrate a metering unit according to the invention comprising the casing 1 with the door 3 kept closed in the closed position POFF on the fixed part 2 in the locked state E1 by the locking device 13 and showing the selection element 12 in the first position P1. The locking device 13 comprises the first locking element 14 and the second locking element 15. The selection element 12 is in the first position P1 and therefore the second locking element 15 is in the locking position PV. As a result, since the second locking element 15 is in the locking position PV, then the first locking element 14 locks the door 3 in the locked state E1. In fact, the latch 18 is against the protrusion 20, which prevents any rotation of the door 3 and therefore its passing to the unlocked state E2.

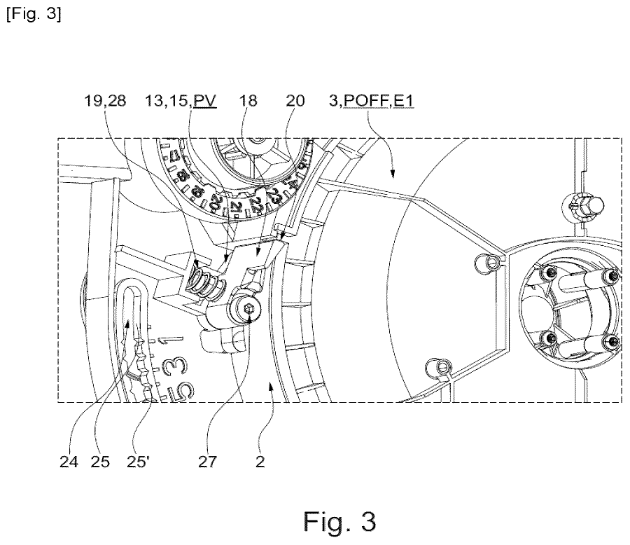

FIG. 3 partially illustrates the metering unit of FIGS. 1 and 2 and shows that in the locking position PV of the second locking element 15, which comprises the latch 18, the latter is against the protrusion 20 which prevents any rotation of the door 3 and therefore its passing to the unlocked state E2. The door 3 is kept closed in the closed position POFF.

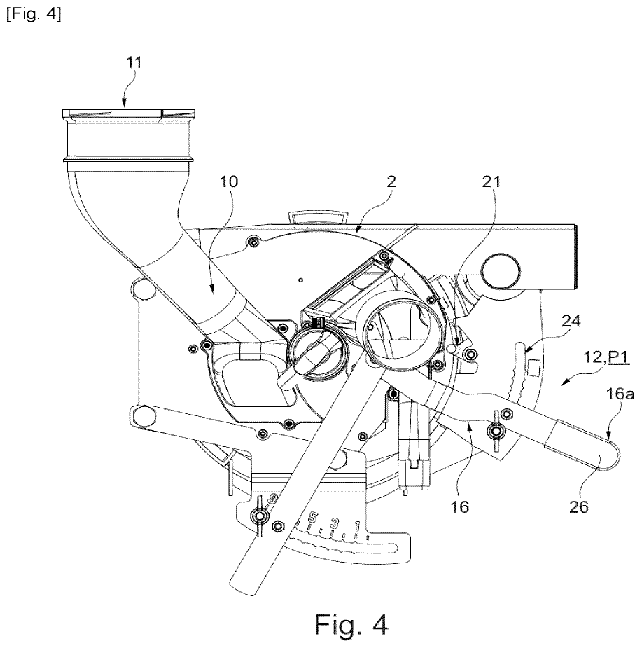

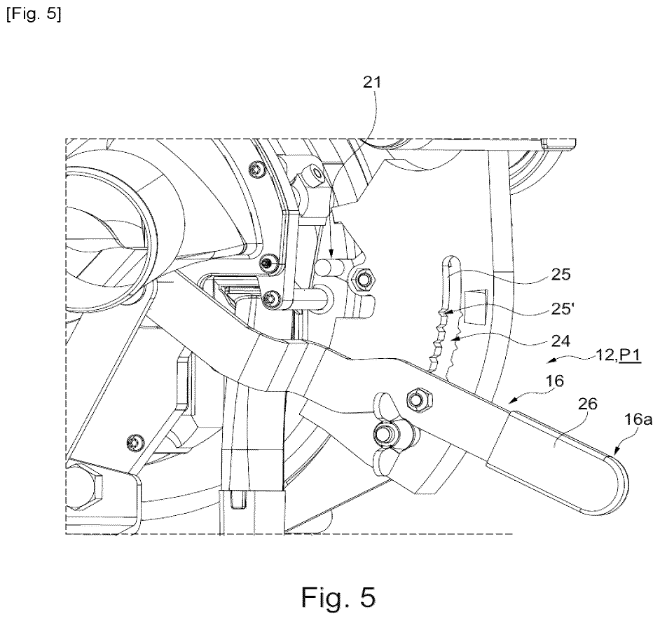

FIGS. 4 and 5 illustrate the metering unit of the preceding figures and show that if the selection element 12 is in the first position P1, the lever 16 is at a distance from the operable portion 21 of the latch 18 and does not operate it.

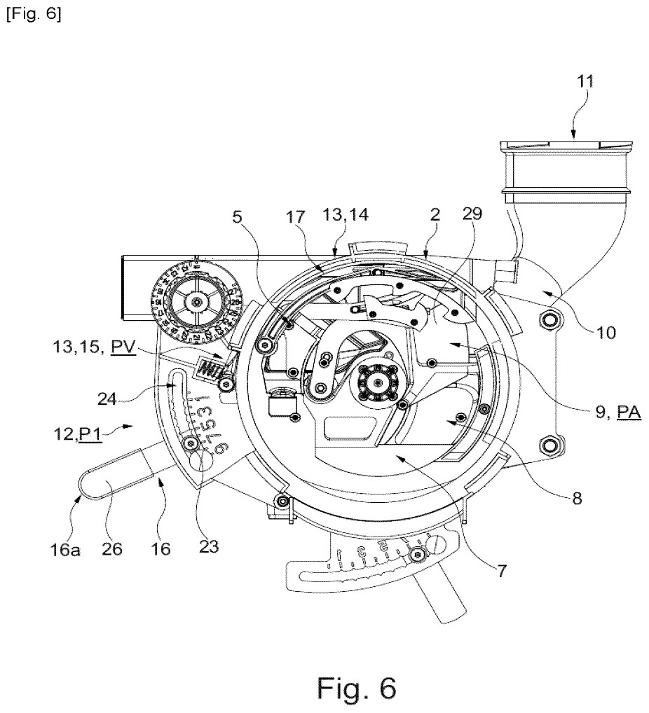

FIG. 6 illustrates the metering unit of the preceding figures without the door 3 and shows the selection element 12 in the first position P1 so that the shutter 9 is in the access position PA. The inlet 8 for granular elements is located in the fixed part 2 and opens into the first chamber 5. The inlet 8 consists of an opening. The shutter 9 is in the access position PA in which it only partially covers the inlet 8.

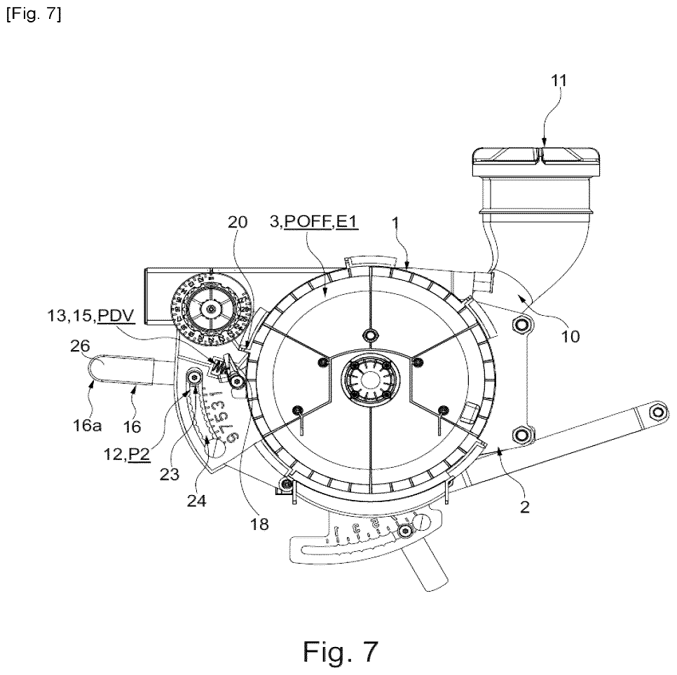

FIG. 7 illustrates the metering unit which differs from that of FIGS. 1 and 2 in the position of the selection element 12 and of the second locking element 15. The selection element 12 is in the second position P2 and therefore the second locking element 15 is in the unlocking position PDV. As a result, since the second locking element 15 is in the unlocking position PDV, then the door 3, which is screwed onto the fixed part 2 and is in the locked state E1, can pass from the locked state E1 to the unlocked state E2. In fact, the latch 18 is at a distance from the protrusion 20, which allows the door 3 to rotate and therefore to pass to the unlocked state E2, in the example illustrated this rotation can take place counter-clockwise.

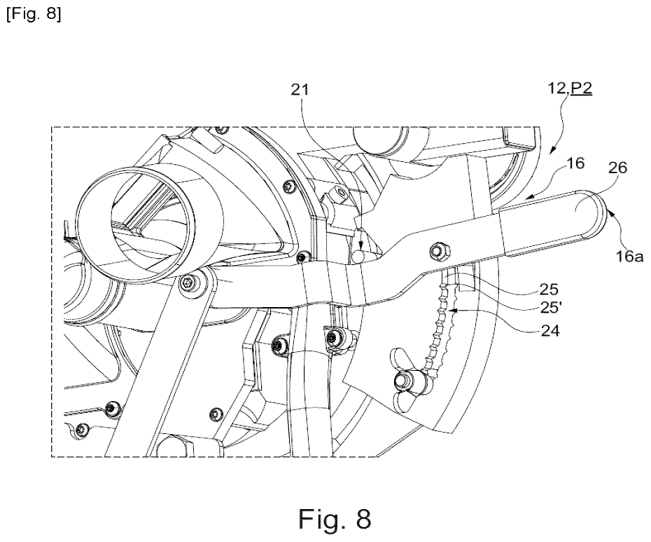

FIG. 8 partially illustrates the metering unit of FIG. 7 and shows that if the selection element 12 is in the second position P2, the lever 16 is in contact with the operable portion 21 of the latch 18 and operates it.

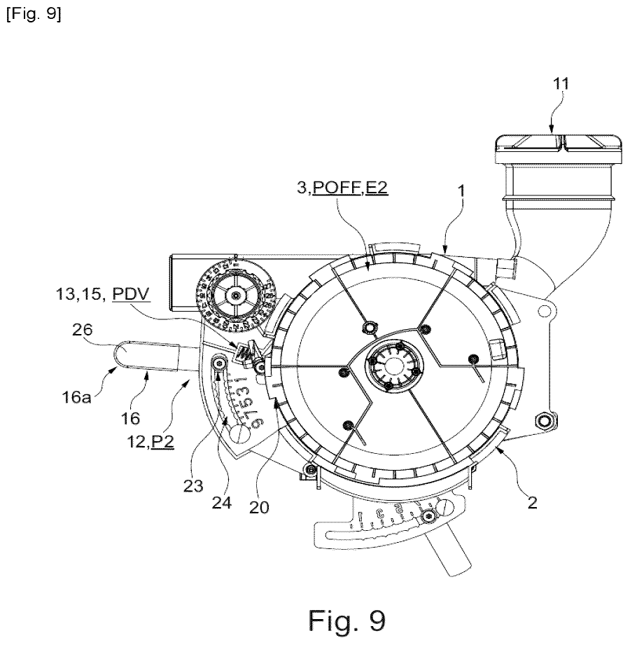

FIG. 9 illustrates the metering unit which differs from that of FIG. 7 in the fact that the door 3 is now in the unlocked state E2 and can therefore pass from the closed position POFF in which it is located to the open position PON. In fact, the door 3 is unscrewed from the fixed part 2 in the unlocked state E2, but is no longer attached to the fixed part 2 and can therefore be removed from the fixed part 2 so as to no longer cover the opening 17 and to be placed in the open position PON.

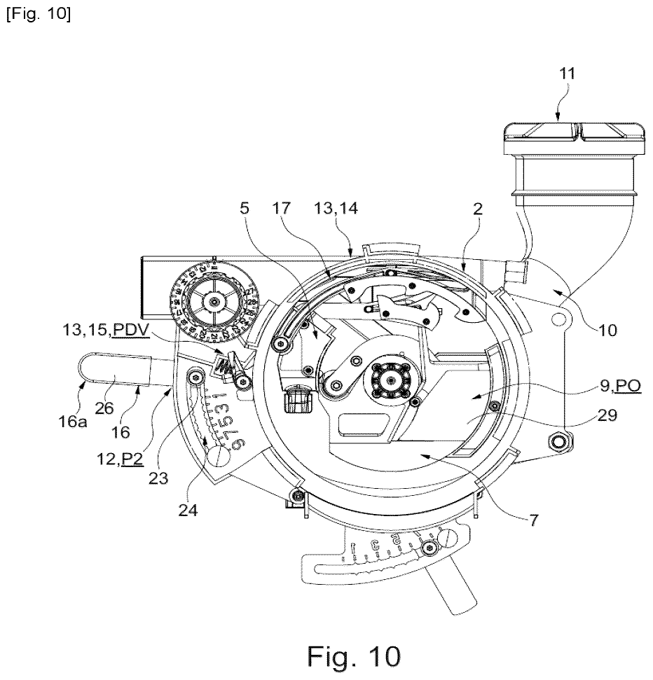

FIG. 10 illustrates the metering unit which differs from that of FIG. 9 in that the door 3 is removed from the fixed part 2 and no longer covers the opening 17. Furthermore, it is observed that, given that the selection element 12 is in the second position P2, the shutter 9 is in the sealed position PO in which it completely covers the inlet 8 by its flat portion 29.

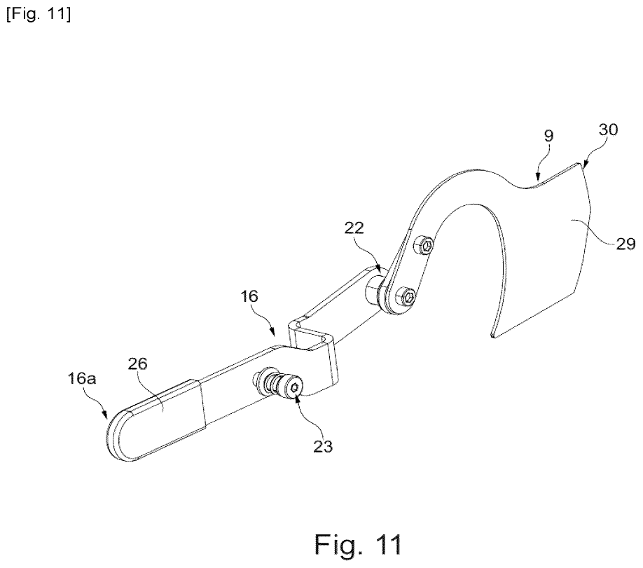

FIG. 11 illustrates a part of the selection element 12, namely the lever 16 and the shutter 9. The lever 16 is connected to the shutter 9 by the fastening means 22. The lever 16 comprises at its free end 16a the gripping device 26. The shutter 9 comprises the flat portion 29 at its free end 30 opposite the free end 16a of the lever 16.

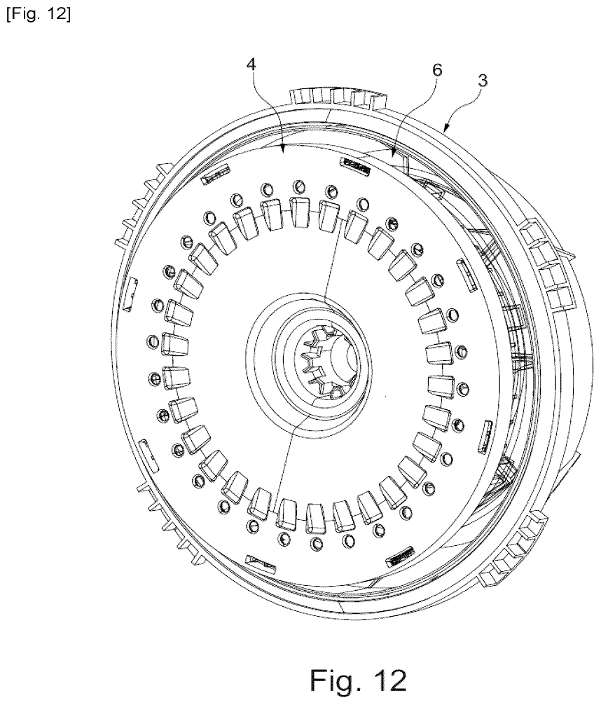

FIG. 12 illustrates the door 3 and the metering element 4 of the metering unit. The metering element 4 is in the form of the drilled metering disc. The door 3 receives the metering disc which forms the second chamber 6. The door 3 is cylindrical.

Obviously, the invention is not limited to the embodiments described and shown in the attached drawings. Modifications remain possible, in particular as regards the composition of the various elements or the substitution by technical equivalents without departing from the scope of protection of the invention.

1. A metering unit for a seed drill comprising at least:
an airtight casing comprising at least a fixed part and a door that can be moved between an open position and a closed position,
a metering element for a plurality of granular elements, arranged for discrete and singular distribution of a plurality of granular elements,
the metering element being placed inside the casing to separate the interior of the casing into a first chamber and a second chamber, which are different, the first chamber being configured to receive all or part of the plurality of granular elements at least in a reserve zone, and the second chamber being closed with the door at least in its closed position,
the fixed part of the casing further comprises an inlet for granular elements leading into the first chamber associated with a shutter, said inlet for granular elements being configured to be connected to conveying means connected to a hopper,
the shutter being operable by a selection element to at least selectively place the shutter in a sealed position of the inlet for granular elements in which the shutter seals the inlet for granular elements, or in an access position of the inlet for granular elements in which the shutter does not fully or partially seal the inlet for granular elements,
in the closed position, the door is at least locked in a locked state or unlocked in an unlocked state at least by a locking device,
the metering unit is one wherein:
in the closed position of the door, the locking device and the selection element are configured so that:
as long as the shutter is in the access position or is not in the sealed position, the door is held in the locked state by the locking device, and
operation of the selection element to pass the shutter from the access position to the sealed position causes operation of the locking device so as to allow the door to pass to the unlocked state or cause the door to pass to the unlocked state.

2. The metering unit according to claim 1, wherein the locking device comprises a first locking element and a second locking element, in the closed position, the door is at least locked in the locked state or unlocked in the unlocked state at least by the first locking element, the second locking element can be moved between a locking position and an unlocking position, and in the closed position of the door, the second locking element and the selection element are configured to cooperate with each other so that:
the second locking element remains in the locking position as long as the shutter is in the access position or is not in the sealed position so as to prevent the unlocking of the first locking element in order to hold the door in the locked state, and
the operation of the selection element to pass the shutter to the sealed position causes the second locking element to pass from the locking position to the unlocking position so as to authorize the unlocking of the first locking element and the passing of the door from the locked state to the unlocked state.

3. The metering unit according to claim 2, wherein in the at least one access position of the shutter corresponding to at least a first position of the selection element, the selection element is configured not to operate the second locking element so that it remains in the locking position.

4. The metering unit according to claim 2, wherein in the sealed position of the shutter corresponding to a second position of the selection element, the selection element is configured to operate the second locking element so that it is in the unlocking position.

5. The metering unit according to claim 3, wherein the selection element comprises a lever mounted so as to be mobile on the fixed part of the casing, at least selectively positionable in the at least one first position and the second position and being mechanically connected to the shutter, and preferably comprising a gripping device so as to manually operate the lever.

6. The metering unit according to claim 1, wherein in the closed position, the door covers an opening of the fixed part, the door being mounted so that it can be screwed/unscrewed relative to said opening by the first locking element in the closed position between the locked state in which the door is screwed on and the unlocked state in which the door is unscrewed.

7. The metering unit according to claim 6, wherein the second locking element comprises a latch pivotally mounted on the fixed part of the casing between the locking position and the unlocking position and reset by reset means mounted on the fixed part of the casing and a protrusion protruding from the outer periphery of the door, the latch being held against the protrusion by the reset means in the locking position so as to prevent the rotation of the door to keep the door in the locked state, and the latch being at a distance from the protrusion in the unlocking position so as to allow the rotation of the door to allow the door to pass to the unlocked state.

8. The metering unit according to claim 5, wherein the latch comprises a portion operable by the lever and when passing to the second position, the lever is configured to operate the operable portion and to exert a force against the return force of the reset means and pivot the latch into the unlocking position.

9. A seeder element comprising at least one hopper arranged to contain a plurality of granular elements and being connected by the conveying means to the metering unit, wherein the metering unit is in accordance with any one of claim 1.

10. A seed drill comprising at least one chassis on which at least one seeder element is mounted, wherein the at least one seeder element is in accordance with claim 9.

11. A locking/unlocking method for a metering unit for a seed drill comprising a plurality of granular elements at least in the reserve zone, wherein the metering unit is in accordance with claim 1, and the method comprises:
a locking stage, during which in the closed position of the door, the shutter is placed in the access position and the door is held in the locked state by the locking device, and
an isolation stage, during which in the closed position of the door, the selection element is operated to pass the shutter from the access position to the sealed position and causes operation of the locking device so as to allow the door to pass to the unlocked state or to cause the door to pass to the unlocked state).
